(19) United States
(12) Patent Application Publication
(10) Pub. No.: US 2025/0099909 A1
(43) Pub. Date: Mar. 27, 2025

(54) FLUE GAS POLISHING SYSTEM

(71) Applicant: FuelCell Energy, Inc., Danbury, CT (US)

(72) Inventors: Stephen JOLLY, Middlebury, CT (US); Frank J. CHIMBOLE, Bethany, CT (US); Hossein GHEZEL-AYAGH, New Milford, CT (US)

(21) Appl. No.: 18/886,051

(22) Filed: Sep. 16, 2024

Related U.S. Application Data
(60) Provisional application No. 63/585,018, filed on Sep. 25, 2023.

(51) Int. Cl. B01D 53/14; B01D 53/34; B01D 53/50; B01D 53/78

(52) U.S. Cl. CPC B01D 53/1481; B01D 53/1412; B01D 53/1493; B01D 53/346; B01D 53/502; B01D 53/78; B01D 2251/106; B01D 2251/304; B01D 2251/604; B01D 2257/302; B01D 2258/0283

(57) ABSTRACT

A caustic scrubber for removing SO₂ from flue gas for use in a fuel cell assembly includes a caustic scrubber tower including a packed bed of material, a flue gas inlet configured to direct a flue gas into the caustic scrubber tower, a scrubber solution pump configured to pump a scrubber solution including NaOH and H₂O₂ into the caustic scrubber tower, and a spent scrubber solution outlet configured to discharge spent scrubber solution including sulfur salts formed from a reaction between the scrubber solution and SO₂ in the flue gas.

### CROSS-REFERENCE TO RELATED APPLICATION

This application claims the benefit of and priority to U.S. Provisional Patent Application No. 63/585,018, filed on Sep. 25, 2023, which is incorporated by reference herein in its entirety.

### BACKGROUND

The present application relates to fuel cell power production systems and, in particular, to the purification of flue gas from conventional power plants so that such flue gas may be used in fuel cells.

A fuel cell is a device that directly converts chemical energy stored in hydrocarbon fuel into electrical energy by means of an electrochemical reaction. Generally, a fuel cell comprises an anode and a cathode separated by an electrolyte matrix, which conducts electrically charged ions. In order to produce a useful power level, a number of individual fuel cells are stacked in series with an electrically conductive separator plate between each cell.

Molten carbonate fuel cells may be used to isolate and capture carbon dioxide from flue gas that is exhausted from coal and natural gas power plants. The flue gas may be fed to the cathode of a fuel cell, where carbon dioxide and oxygen react to form carbonate ions. The carbonate ions travel through the electrolyte matrix to the anode, where they react with hydrogen to form water and carbon dioxide. The carbon dioxide may be sequestered or used in other industrial processes to reduce the carbon footprint of the power plant.

However, molten carbonate fuel cells are sensitive to contaminants such as SO₂, SO₃, and particulate matter, which can reduce the efficiency and lifespan of the cells. These contaminants are typically present in relatively high concentrations in power plant flue gas. Accordingly, it would be advantageous to provide a system that reduces contaminant levels before the flue gas is directed to the fuel cells.

### BRIEF DESCRIPTION OF THE DRAWINGS

FIG. 1 shows a schematic view of a flue gas polishing system in accordance with an exemplary embodiment.

FIG. 2 shows a schematic view of a caustic scrubber of the system of FIG. 1, in accordance with an exemplary embodiment.

FIG. 3 shows a method of controlling the level of H₂O₂ in a scrubber solution in the system of FIG. 1, in accordance with an exemplary embodiment.

FIG. 4 shows a schematic view of a baghouse of the system of FIG. 1, in accordance with an exemplary embodiment.

FIG. 5 shows a schematic diagram of a mist eliminator of the system of FIG. 1, in accordance with an exemplary embodiment.

FIG. 6 is a diagram of a bench-scale caustic scrubber used during testing.

It will be recognized that the figures are schematic representations for purposes of illustration. The figures are provided for the purpose of illustrating one or more implementations with the explicit understanding that the figures will not be used to limit the scope of the meaning of the claims.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

As shown and described below, the present invention provides a polishing system for the reduction of SO₂, SO₃, particulate matter (PM), and other contaminants in power plant flue gas. Molten carbonate fuel cells can separate carbon dioxide from a flue gas stream for sequestration or other industrial uses, thus reducing the carbon footprint of the power plant. However, SO₂, SO₃, PM, and other contaminants in flue gas can reduce the efficiency and lifespan of the fuel cells. Accordingly, it is beneficial to remove these contaminants from the flue gas prior to directing the flue gas to the fuel cells.

According to an exemplary embodiment, a flue gas polishing system is provided for removing SO₂, SO₃, PM, and other contaminants in a power plant flue gas stream. The system includes a caustic scrubber that applies a scrubber solution to the flue gas to reduce the levels of SO₂ in the flue gas. After passing through the caustic scrubber, the flue gas is heated and pressurized by a blower and directed to a baghouse, where the flue gas passes through fabric filter socks that capture PM. The flue gas is then directed to a mist eliminator, which includes demister pads configured to capture SO₃ and residual PM in the flue gas. Treating the flue gas in the caustic scrubber and the baghouse improves the removal rate of SO₃ in the mist eliminator because there is less PM that may accumulate on the demister pads causing a reduction the efficiency of the mist eliminator. The flue gas polishing system may reduce the SO₂ in the flue gas by as much as 99.99%, reduce the SO₃ by as much as 99.9%, and reduce the PM to approximately 5-25 micrograms per cubic meter (the typical detection limit range).

### Contaminant Monitoring

Generalized coal power plant flue gas concentrations entering the polishing system are shown in Table 1 below according to one particular embodiment. It should be noted that the values in Table 1 represent flue gas concentrations from an example coal power plant and that input concentrations may vary based on the source of the flue gas. For example, the input concentrations may vary significantly based on differences in fuel type (coal, natural gas, etc.) the particular plant or source (e.g., flue gas from two different coal plants may have different contaminant concentrations) or the particular operating conditions of a single source over time. The flue gas may be received from other types of power plants, as well as other industrial sources including manufacturing plants.

TABLE 1
Generalized Coal Power Plant Flue Gas Inlet Concentrations

| | |
|---|---|
| Temperature, deg. F. | 131 |
| Composition, v/v % | Wet |
| N2 | 66-74 |
| CO₂ | 10 to 12 |
| O2 | 4 to 6 |
| H2O | 13 to 16 |
| SOx | 12 ppm dry |
| (S02), (S03) | 10 ppm dry, 2 ppm dry |
| HCI | 2 ppm |
| Se, As | 0.012 ppm, 0.016 ppm¹ |
| PM | 85,000 pg/M² |
| Design Slip Stream Flow Rate | 10,000 scfm Operating |
| for Demonstration System | 12,000 scfm Maximum |

The inlet values for selenium and arsenic are estimated from coal power plant emissions literature. The polishing system is most concerned with the removal of SO₂, SO₃, and PM to allow for the efficient operation of fuel cells using the polished flue gas. However, other contaminants may be removed by this system as well. The target concentrations for use in a fuel cell, as well as the expected concentrations after polishing with the systems disclosed herein, are shown in Table 2 below. It should be noted that these are example target concentrations, and systems may require different concentrations depending on the planned use of the polished flue gas as well as the initial input concentrations.

TABLE 2
Polishing System Concentrations

| Constituents of | Inlet From | | Target to | | Min. Detection | | Expected | |
|---|---|---|---|---|---|---|---|---|
| Concern | Plant | | Fuel Cell | | Limit | | Conc. to Fuel Cells | |
| SOₓ (Total SO₂ + SO₃) | 12 | ppm dry | <10 | ppb Total Soₓ | | | <0.003 | ppb total Soₓ |
| SO₂ | 10 | ppm dry | | | <0.010 to 0.1 | ppm | <0.001 | ppm |
| SO₃ | 2 | ppm dry | | | ~0.1 | ppm | <0.002 | ppm |
| HCI | 2 | ppm | < 0.040 | ppm | <0.040 | ppm | 0.002 | ppm |
| Se | 0.012 | ppm¹ | <0.010 | ppm | < 0.010 | ppm | 0.001 | ppm |
| As | 0.016 | ppm¹ | <0.010 | ppm | < 0.010 | ppm | 0.001 | ppm |
| PM | 85,000 | μg/m³ | 85 | μg/m³ | 5-25 | μg/m³ | <5-25 | μgJm³ |

As discussed above, inlet values for selenium and arsenic are estimated from coal power plant emissions literature.

An analyzer system may be used for continuous monitoring of SO₂ and SO₃/H₂SO₄ concentrations, as well as HCl, CO₂, NO, NO₂, O₂, and H₂O. The analyzer's detection limits for SO₂, SO₃/H₂SO₄, and HCl may be sufficient for the concentrations in the inlet flue gas and for SO₂ and HCl at the expected low concentrations at the mist eliminator outlet. The analyzer may enable alarms to be set to notify the system of increases or decreases in SO₂, SO₃, and HCl in the flue gas flowing into the flue gas polishing system. This may enable control decisions to alter the operating mode of the system to prevent operation beyond specified limits.

PM may be measured by discrete sampling and gravimetric analysis during baseline acceptance testing. Once established, it is unlikely to change as long as the main plant operation remains at a consistent baseload output.

Concentrations of CO₂, NO and NO₂ (NOx), O₂, and H₂O are also of importance for plant process control. Those constituents exist at sufficient levels in the flue gas for adequate analyzer performance and may also be monitored. The analyzer may notify the system of changes in levels of CO₂ or O₂ in the flue gas and allow controls to adjust operations to compensate for such changes in the flue gas feed.

### Flue Gas Polishing System

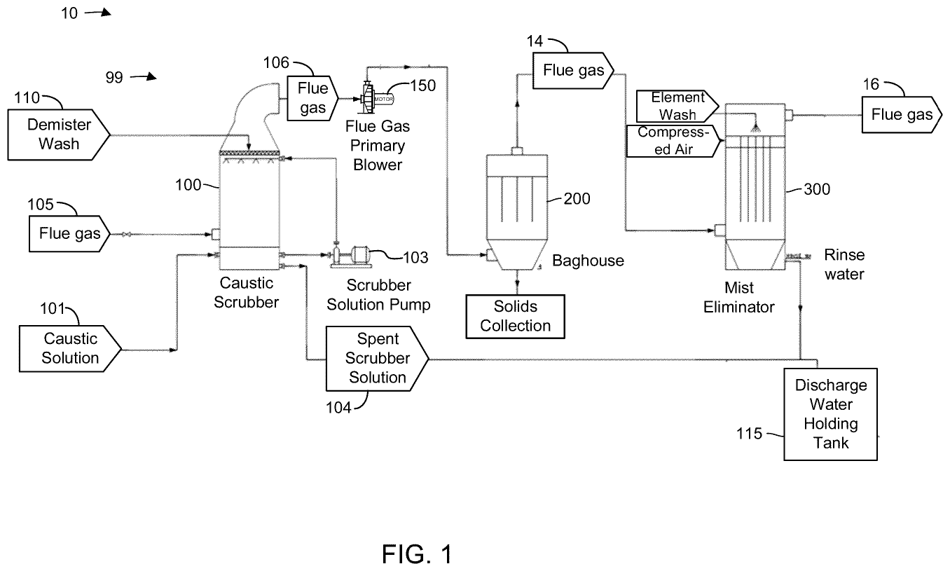

Referring to FIG. 1, a diagram of the major components of a polishing system 10 is shown. A flue gas stream 105 is first fed into a caustic scrubber 100 that removes SO₂ from the flue gas 105 and outputs a scrubbed flue gas stream 106 containing less than 0.01 ppm SO₂. The scrubbed flue gas stream 106 is directed to a primary flue gas blower 150, which heats the scrubbed flue gas stream 106 to a temperature of approximately 180° F., above the dew point of the scrubbed flue gas stream 106, by the heat of compression. The heated scrubbed flue gas stream 106 is then fed to a baghouse 200 that includes several fabric filter socks. PM in the scrubbed flue gas stream 106 accumulates on the socks as the scrubbed flue gas stream 106 passes through. The baghouse 200 then outputs a filtered flue gas stream 14 with particulate levels below approximately 85 micrograms per cubic meter. Finally, the filtered flue gas stream 14 output from the baghouse 200 is directed to a mist eliminator 300, which traps and removes the aerosolized SO₃ and remaining fine PM in the filtered flue gas stream 14. The mist eliminator 300 outputs a polished flue gas stream 16. The system 99 may reduce SO₃ levels in the flue gas stream 105 as much as 99.9% to approximately 0.002 ppm and PM can be reduced to approximately 5-25 micrograms per cubic meter (the typical detection limit range). Spent scrubber solution 104 from the caustic scrubber 100 and rinse water from the mist eliminator are sent to a discharge water holding tank 115 for disposal. Each major system component is discussed in detail below. It should be understood that the detection limits disclosed herein relate to example analysis tools, and that other tools with higher or lower detection limits may be included.

In some embodiments, the baghouse 200 may precede the caustic scrubber 100 when the flue gas 105 is above its dew point and/or when the flue gas 105 is at a high temperature, as the baghouse 200 may be able to operate at higher temperatures than the caustic scrubber 100. In that case, a primary blower 150 may not be necessary to heat the flue gas using the heat of compression. If the caustic scrubber 100 precedes that baghouse 200, the primary blower 150 may be necessary to heat the scrubbed flue gas stream 106 above the dew point to prevent clogging of the baghouse filter socks. The mist eliminator 300 is preferentially preceded by both the caustic scrubber 100 and the baghouse 200 to prevent additional PM and SO₂ from reaching the mist eliminator 300, which could impact the performance and service life of the mist eliminator 300. The mist eliminator may include relatively fine filters that may quickly become clogged if the flue gas 105 is not first treated in the caustic scrubber 100 and the baghouse 200. The primary blower 150 may follow the mist eliminator, however, this may also impact the performance and service life of the mist eliminator 300, and the scrubbed flue gas stream 106 would not be heated by the heat of compression prior to entering the baghouse 200.

### Caustic Scrubber

Power plant flue gas from coal and biomass power plants have average SO₂ concentrations of around 10 ppm. This level can occasionally raise to 20 ppm for extended periods of time and as high as 78 ppm for shorter periods. For ideal fuel cell operation, this concentration should preferably be reduced to approximately 0.01 ppm or less. Caustic scrubbers traditionally use a NaOH caustic solution that can reduce the level of SO₂ by approximately 99.63%. The caustic scrubber of the present application uses a scrubber solution that may include both NaOH and H₂O₂. Testing has shown that a solution containing NaOH and H₂O₂ and maintained at a pH of above approximately 5.0 and below approximately 5.5 results in a 99.99% reduction in SO₂ in flue gas containing approximately 20 ppm SO₂. The performance targets for flow rate, temperature, pressure, and SO₂ removal for a caustic scrubber according to an example embodiment are shown in Table 3 below. In some embodiments, different target concentrations may be desired.

TABLE 3
Caustic Scrubber Performance Requirements

| | INLET | OUTLET |
|---|---|---|
| Flow (acfm) | 1,450 | 10,450 |
| Temperature (° F.) | 131 | 131 |
| Pressure (psia) | 14.3 | 14.2 |
| (ppm) | 10 | 0.01 |

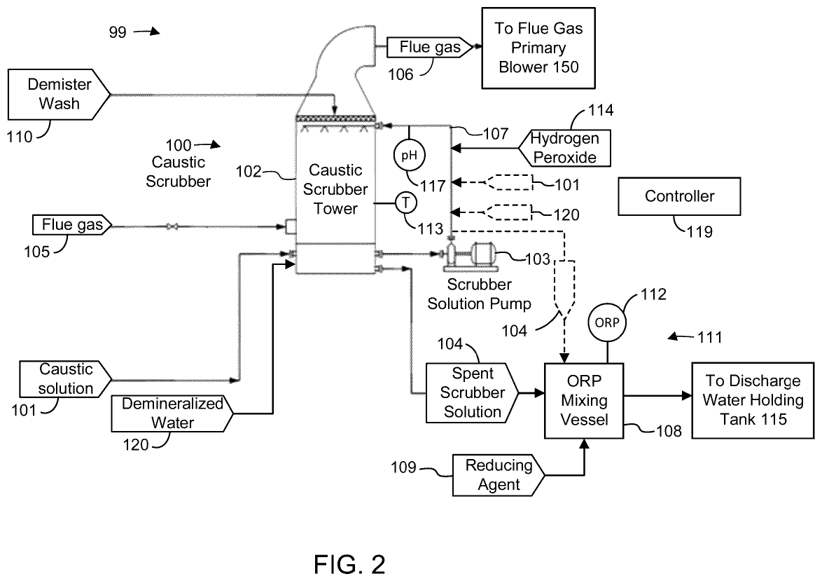

FIG. 2 illustrates a caustic scrubber system 99 according to an exemplary embodiment. Caustic solution 101 may be pumped into the bottom of the caustic scrubber tower 102 (e.g., the sump of the caustic scrubber tower 102). The caustic solution may include NaOH. The caustic solution may be combined with hydrogen peroxide (H₂O₂) from a hydrogen peroxide supply 114 (e.g., a storage tank) and/or water from a water supply 110 (e.g., a storage tank) to form a scrubber solution. The caustic scrubber tower 102 may contain a packed bed of material for the flue gas stream 105 to pass through. A scrubber solution pump 103 may pump the scrubber solution to the top of the caustic scrubber tower 102, where it may be sprayed over the packed bed of material. The scrubber solution may drip through the packed bed of material back down to the bottom of the caustic scrubber tower 102, where it may be recirculated to the top of the tower 102 by the pump 103. A portion of the scrubber solution may be discharged from a spent scrubber solution outlet at the bottom of the tower 102 as spent scrubber solution 104. This cycle may be run on a continuous basis, with fresh scrubber solution components being introduced into the tower 102 while a roughly equal amount of spent scrubber solution 104 is discharged from the tower 102. Spent scrubber solution 104 may be discharged at a rate of approximately 0.5 to 1.0 gallons per minute.

While the scrubber solution 107 is being cycled through the tower 102, flue gas stream 105 may be introduced to the tower near the bottom of the tower 102. The flue gas stream 105 may travel up through the packed bed of material in the tower 102 and react with the scrubber solution 107. The flue gas stream 105 may contain SO₂. The average concentration of SO₂ in the flue gas stream 105 may be approximately 10 ppm or more, or approximately 20 ppm or more. The concentration of SO₂ in the flue gas stream 105 may reach levels as high as 78 ppm.

The SO₂ in the flue gas stream 105 may react with the NaOH and H₂O₂ in the scrubber solution 107 to form sulfur salts that may remain in the scrubber solution 107 while a scrubbed flue gas stream 106 is output the tower 102 near the top of the tower 102. The scrubbed flue gas stream 106 output from the tower 102 may have a substantially lower concentration of SO₂ than the flue gas stream 105 after reacting with the scrubber solution 107 in the tower 102. The packed bed of material may increase the contact area between the scrubber solution 107 and the flue gas stream 105, thus increasing the amount of reaction between the SO₂ and the scrubber solution 107.

Experimental data has shown that a scrubber solution containing NaOH may remove approximately 99.63% of the SO₂ from the flue gas stream 105. A scrubber solution containing NaOH and H₂O₂, on the other hand, may remove approximately 99.99% of SO₂ from the flue gas stream 105. The H₂O₂ may act to convert the SO₂ into sulfate ions (SO₄²⁻) which then may react with the NaOH in the scrubber solution 107 to form sulfate salts. The estimated concentrations of ions in spent scrubber solution 104 as it is discharged from an example caustic scrubber 100 when the scrubber solution 107 is maintained at a pH of about 5 are shown in Table 4 below. It should be noted that the values in Table 4 relate to an experimental test setup. In some embodiments, these concentrations may vary.

TABLE 4
Caustic Scrubber Estimated Purge Concentrations

| Parameter | Value (mg/L) |
|---|---|
| Sodium | 3,200 |
| Sulfate | 6,700 |
| Carbonate | 200 |
| Sulfite | 0.1 |
| pH | 5 (SU) |

The scrubber solution may have a pH of above approximately 4.5 and below approximately 5.5 (or above approximately 5.0 and below approximately 5.5) in order to maximize the removal of SO₂ from the flue gas stream 105. As the NaOH reacts with the SO₂ to form salts, the scrubber solution may become more acidic, thus causing the pH to drop. The caustic scrubber system 99 may include a pH sensor 117 to measure the pH of the scrubber solution 107 and a controller 119 configured to adjust a flow rate of caustic solution 101 input into the tower 102. When the pH of the scrubber solution 107 falls below a predetermined level, such as 5.0, the controller 119 may increase the amount of caustic solution 101 input into the tower 102, for example, by controlling a valve or pump associated with the caustic solution supply. Demineralized water from the host site supply 120 may be added to the scrubber solution 107 to replace the water discharged in the spent scrubber solution 104 that is discharged from the tower, keeping the volume of scrubber solution 107 in the tower 102 substantially constant. The controller 119 may include at least one processor and at least one memory device. The at least one memory device may store instructions that, when executed by the one or more processors, cause the controller 119 to execute the functions described herein. The controller 119 may be communicably coupled to and configured to send control instructions to various valve controllers, actuators, processors, and other components of the system 10. The controller 119 may also be communicably coupled to and configured to receive information from various sensors and other components of the system 10, including the pH sensor, an ORP sensor 112 (discussed below), and/or a temperature sensor 113 (discussed below).

The amount of H₂O₂ to be mixed into the scrubber solution 107 may be determined by the amount of SO₂ in the flue gas stream 105. A higher volume of H₂O₂ may be added to the solution 107 when the level of SO₂ in the flue gas stream 105 is higher. Furthermore, additional H₂O₂ may be introduced to the scrubber solution 107 to replace any H₂O₂ that has reacted with the SO₂. Accordingly, a sensor may be used to determine whether the level of H₂O₂ in the solution 107 is able to remove to remove a desired amount of SO₂. In some embodiments, the oxidation reduction potential (ORP) of the spent scrubber solution 104 may be used to determine whether the level of H₂O₂ in the scrubber solution 107 is able to remove the desired amount of SO₂ from the flue gas stream 105. However, testing has shown that, above a certain saturation point, the ORP of the spent scrubber solution 104 may not increase, even with the addition of more H₂O₂ to the solution 107 thus limiting the ability to determine whether the desired amount of SO₂ is being removed using the ORP. In a test setup, the ORP of the solution did not increase above approximately 300 mV as additional H₂O₂ was added. As SO₂ concentrations in the flue gas stream 105 may vary over time, a sensor that is reactive to these changes may be desired.

Referring further to FIG. 2, the caustic scrubber system 99 may include an ORP measuring system 111 for measuring the level of unreacted H₂O₂ in the spent scrubber solution 104, according to an exemplary embodiment. Spent scrubber solution 104 that is discharged from the tower 102 may be directed to an ORP mixing vessel 108. A reducing agent 109 may also be directed to the mixing vessel 108. The spent scrubber solution 104 and the reducing agent 109 may be added to the vessel 108 in a continuous stream to maintain a uniform ratio. The reducing agent 109 may be sodium metabisulfite, sodium sulfite and/or sodium bisulfite, or any other reducing agent capable of neutralizing H₂O₂. In the ORP mixing vessel 108, the reducing agent 109 may be mixed with the spent scrubber solution 104 and may react with and neutralize a portion of the H₂O₂ in the spent scrubber solution 104. In some embodiments, the flow rate of the reducing agent 109 may be approximately equal to the flow rate of the spent scrubber solution 104 into the ORP mixing vessel 108. The vessel 108 may include an ORP sensor 112 to measure the ORP of the mixed solution. The ORP sensor 112 may be communicatively coupled to the controller 119. If the ORP in the mixing vessel 108 remains high, even after the reducing agent has neutralized some of the H₂O₂, the level of H₂O₂ in the scrubber solution 107 in the tower 102 may be adequate to remove the SO₂ from the flue gas stream 105. If the reducing agent causes the ORP in the mixing vessel 108 to drop below a predetermined minimum level, the controller 119 may cause additional H₂O₂ to be introduced into the scrubber solution 107, for example, by controlling a valve or pump associated with the hydrogen peroxide supply 114. The ORP mixing vessel 108 may be a closed vessel to prevent the reducing agent 109 from reacting with atmospheric oxygen. For example, the instructions stored in the memory device of the controller 119 may include an upper ORP limit and a lower ORP limit. The controller 119 may periodically or continuously receive an ORP reading from the ORP sensor 112. When the ORP reading indicates that the ORP in the mixing vessel 108 exceeds the upper ORP limit, the controller may cause the system 99 to reduce the rate that H₂O₂ is added into the scrubber solution 107. When the ORP reading indicates that the ORP in the mixing vessel 108 is lower than the lower ORP limit, the controller 119 may cause the system 99 to increase the rate that H₂O₂ is added into the scrubber solution 107.

The tower 102 may include a temperature sensor 113 to measure the temperature of the scrubber solution 107. The temperature sensor 113 may be communicatively coupled to the controller 119. If the temperature rises above a predetermined limit, the controller 119 may input additional demineralized water into the solution 107, for example, by opening a valve between the water supply 110 and the tower 102. The flow rate of spent scrubber solution 104 may be increased to account for the additional volume of scrubber solution 107 in the tower 102.

The caustic solution 101, H₂O₂, and water inputs are not limited to the arrangement shown in FIG. 2. The scrubber solution components may be added to the tower or into the pump recycle stream (e.g., as shown in dashed lines in FIG. 2) after any discharge points to form the scrubber solution 107 that is applied to the top of the tower 102 and then collects in the sump (e.g., the bottom of the tower 102). For example, the caustic solution 101, H₂O₂, and water may all be introduced near the bottom of the tower 102 or may be mixed before being introduced into the tower 102. The spent scrubber solution 104 can be drained from the sump or discharged after the recycle pump ahead of any input streams 101, 120, 114 (e.g., as shown in dashed lines in FIG. 2). The scrubbed flue gas stream 106 discharged from the top of the caustic scrubber tower 102 may be directed to a primary blower 150 and a baghouse 200 for particulate removal.

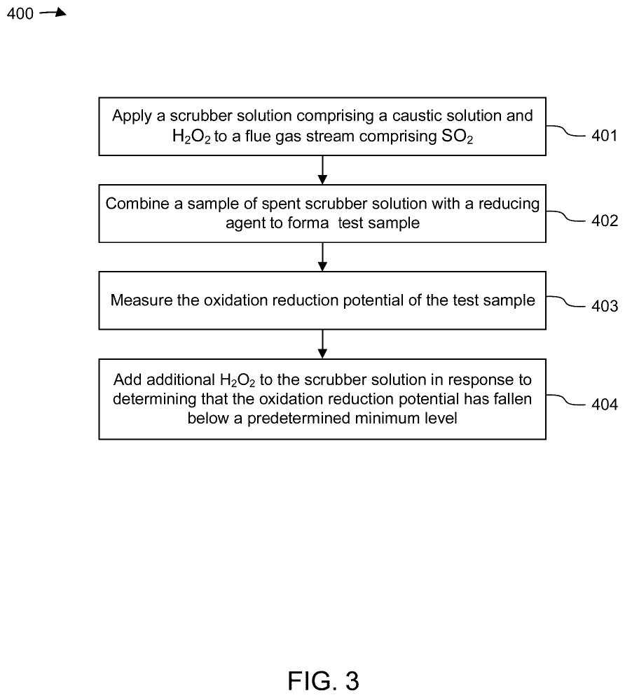

FIG. 3 illustrates a method 400 of controlling the amount of H₂O₂ added to a scrubber solution of a caustic scrubber (e.g., the scrubber solution 107 in caustic scrubber 100). At operation 401 of the method 400, a scrubber solution comprising caustic solution and H₂O₂ is applied to a flue gas stream comprising SO₂. The caustic solution, which may include NaOH, may form salts with the SO₂ to remove the SO₂ from the flue gas stream. At operation 402 of the method 400, a sample of spent scrubber solution is combined with a reducing agent to form a test sample. The spent scrubber solution and the reducing agent may be combined and mixed in a mixing vessel. The spent scrubber solution may include scrubber solution and salts created from the reaction of the scrubber solution and the SO₂ in the flue gas stream. The reducing agent may be sodium metabisulfite, sodium sulfite and/or sodium bisulfite, or any other reducing agent capable of neutralizing H₂O₂. At operation 403 of the method 400, the ORP of the test sample is measured (e.g., using the ORP sensor 112). A decrease in the ORP may indicate an increase in the SO₂ in the flue gas.

At operation 404 of the method 400, additional H₂O₂ is added to the scrubber solution in response to determining that the ORP of the test sample has fallen below a predetermined minimum level. In some embodiments, a flow rate of H₂O₂ into the scrubber solution may be increased in response to determining that the ORP of the test sample has fallen below a predetermined level. The method steps may be repeated continuously to allow for constant monitoring of the oxidation reduction potential. This allows for H₂O₂ to be added quickly when the oxidation reduction potential measurement has fallen below the predetermined level, indicating an increase in the SO₂ level in the flue gas entering the caustic scrubber. The predetermined minimum level of oxidation reduction potential may be between approximately 200 mV and approximately 300 mV. In this range, the detection accuracy may be maximized to ensure that the ORP readings accurately reflect the level of SO₂ in the flue gas entering the caustic scrubber.

### CO₂ Absorption in Caustic Scrubber

The embodiments disclosed herein may reduce or prevent absorption of CO₂ in the caustic scrubber, thus allowing for downstream CO₂ capture. Flue gas from fossil fuel sources may contain approximately 8% CO₂ in a typical natural gas-based source and up to 14% CO₂ in a typical coal-based source. Maintaining an overall acidic pH in the solution may prevent or reduce significant absorption of CO₂ in the scrubber solution when the amount of CO₂ in the gas stream is relatively high. Any CO₂ absorbed in the caustic scrubber solution may be lost for downstream recovery and increases consumption of scrubber feedstock chemicals. However, an acidic solution may also inhibit complete absorption of SO₂. By employing H₂O₂, the SO₂ may be converted to sulfate ions (SO₄²⁻), maximizing SO₂ capture in an acidic environment while minimizing CO₂ absorption.

Testing has shown that significant carbon dioxide removal does not occur if the caustic scrubber has a minimal liquid purge rate at a slightly acidic (5-6) pH relative to the mass flow of CO₂ in the flue gas. The purge rate from the caustic scrubber is typically driven by one of several factors: water balance in the scrubber solution 107, which is affected by condensation from inlet flue gas moisture due to temperature changes; chloride concentration in the scrubber solution 107, high concentrations of which may cause corrosion of the caustic scrubber construction materials; and the concentration of soluble ions in the scrubber solution 107, such as magnesium and sulfate ions.

Since a relatively minimal mass of SO₂ is being converted to sulfate in the scrubber 100, along with minimal chloride buildup, the necessary purge flow may be relatively low. Peroxide does not change the oxidation state of carbon. Therefore, CO₂ forms an equilibrium distribution based on the gas concentration and scrubber solution pH. The ionic equilibrium includes carbonic acid, bicarbonate, and carbonate ions. At slightly acidic pH values, the fraction of carbonic acid in the scrubber solution 107 is balanced against the gas phase concentration. With no other removal mechanism (i.e., precipitation of calcium carbonate), the CO₂ removal is stagnant. The mass removal of CO₂ may be equal to the purge flow times the carbonate concentration and can be relatively low in the caustic scrubber system 99, according to various exemplary embodiments.

### Caustic Scrubber Testing

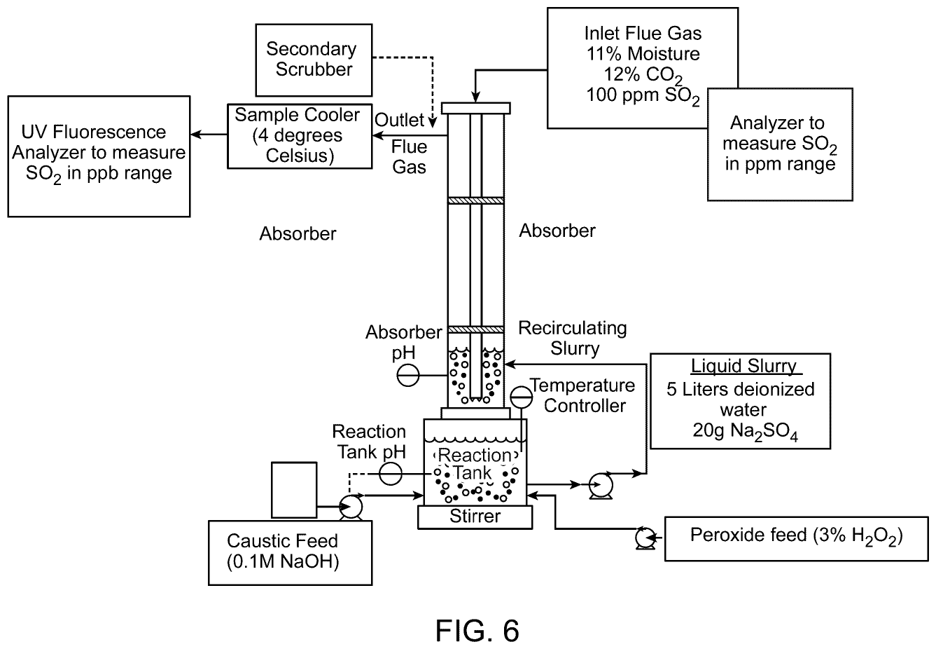

Breakthrough testing was conducted on a bench-scale caustic scrubber using inlet SO₂ concentrations ranging between approximately 20 ppm and 100 ppm and peroxide concentrations ranging between approximately 0.02 wt % and 0.07 wt %. FIG. 6 is a diagram of the bench-scale caustic scrubber used for testing. Breakthrough refers to the consumption of excess peroxide and a return to baseline SO₂ removal using only NaOH. A return to baseline SO₂ removal indicates that additional H₂O₂ is necessary to increase the absorption of SO₂. Results indicated that there was a 1:1 molar correlation of SO₂ removal and H₂O₂ consumption.

Typically, SO₂ removal is driven by liquid phase alkalinity, with higher pH enhancing SO₂ removal efficiency. During testing, it was observed that, when present, the peroxide concentration drove the SO₂ removal efficiency and the SO₂ removal efficiency was no longer correlated with changes in pH, i.e., liquid phase alkalinity. This is a significant process advantage since operation at lower pH nearly eliminates CO₂ absorption.

The potential for NOx in the flue gas to affect the SO₂ removal efficiency was also investigated. Data from one site indicated the inlet flue gas can contain 150 ppm of NOx. Bench-scale testing was performed on a caustic scrubber using excess peroxide, 20 ppm inlet SO₂, and 150 ppm inlet NOx to determine if the presence of NOx would interfere with the kinetics of SO₂ removal. It was found that 150 ppm NOX did interfere with the fluorescent SO₂ analyzer measurement. Using an alternate measurement technique (pull tubes), it was determined that SO₂ removal performance was not hindered by the presence of NOx.

The impact of NOx on peroxide consumption was not evaluated. However, it is noted that when peroxide is used to oxidize NO, it is done at much higher temperatures to vaporize and dissociate the peroxide into hydroxyl radicals to oxidize NO and NO₂ to NO₂, HNO₂ and HNO₃ which are more soluble in a wet FGD process. Therefore, the consumption of the peroxide by the presence of NOx in the target design scrubber is expected to be insignificant. Also, if the polished flue gas is used in fuel cells, the fuel cells may convert ˜70% of the NOx that is emitted from the scrubber to N₂, so NOx will not have a detrimental impact on fuel cells.

To determine the effectiveness of the scrubber chemistry on other acid gases, HCl removal was also evaluated with the bench-scale caustic scrubber using an inlet HCl concentration of 40 ppm. The outlet concentration was measured using pull tubes. HCl was not detected at the outlet (i.e., concentration of <50 ppb HCl) under these loading conditions. As HCl readily dissociates into chloride ions in water, maintaining a solution pH above strong acidic levels (i.e. >0.5) can be expected to eliminate any vapor pressure that could inhibit complete absorption of acid gases.

Selenium levels below 10 ppb may be targeted for use in fuel cells. The median selenium concentration in flue gas from a biomass power plant was found to be approximately 0.6 ppb, well below the acceptable limit without having to remove any selenium. Nevertheless, the amount of selenium removed by the caustic scrubber was tested. Experiments showed that at least 90% of the selenium in the flue gas was removed with various levels of NaOH and H₂O₂ in the scrubber solution, including testing with only demineralized water. In most cases, a majority of the selenium collected on the glass tubing feeding the gas into the scrubber solution and was removed by rinsing the tubing. This suggests that a majority of the selenium will condense out of the flue gas stream before even reaching the caustic scrubber. Any selenium remaining after the flue gas passes through the caustic scrubber may be significantly removed from the flue gas in the mist eliminator 300.

### Baghouse

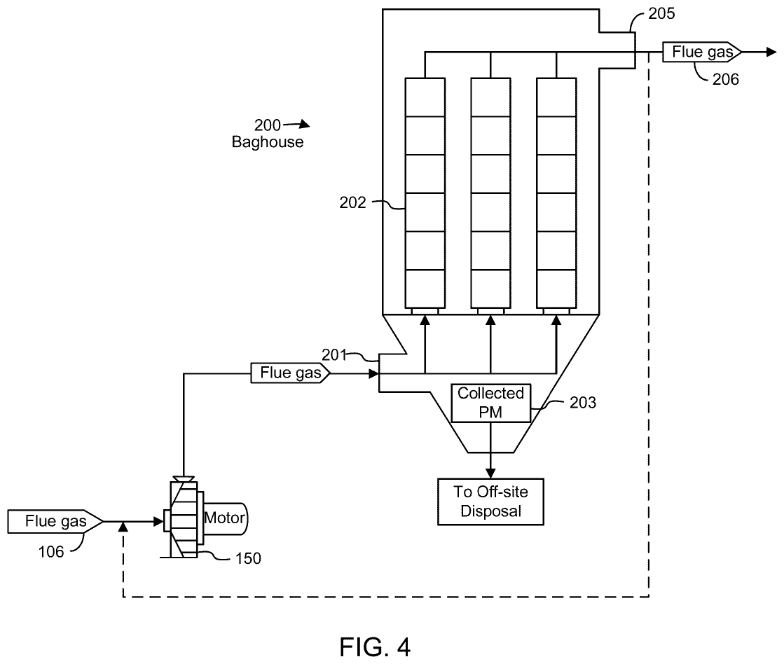

FIG. 4 illustrates a primary blower and a baghouse for removing PM. The flue gas exhausted from a power plant may contain over 85,000 micrograms per cubic meter of PM, which may be too high to be removed effectively by the caustic scrubber. To address this issue, a baghouse may be employed. After the scrubbed flue gas stream 106 is discharged from the caustic scrubber, it may be directed to the primary blower 150, which pressurizes the flue gas 106 and directs it into an inlet 201 of the baghouse 200. Compressing the flue gas 106 increases its temperature due to the heat of compression.

The flue gas in the baghouse 200 may be directed upwards into one or more fabric filter socks 202. The filter socks 202 may collect the PM from the flue gas 106, reducing the amount of PM in the flue gas 106 by as much as 99.9% (e.g., to around 85 micrograms per cubic meter). Because the scrubbed flue gas 106 leaving the caustic scrubber 100 is saturated by the scrubber solution 107, a wet agglomeration of particles is formed, which may be more easily captured on the socks 202 and the inside of the piping and baghouse walls. The pre-heating of the flue gas above the saturation temperature (dew point) 106 before it enters the baghouse 200 may reduce or eliminate the possibility of binding and clogging of the filter fabric. Compressed air may be used to periodically flush the filter socks 202 with pulses of air to agitate and flex the socks 202 causing the accumulated PM to dislodge from and fall off the fabric. The PM solids may fall to the base of the baghouse 200 where they may be accumulated in a container 203 for ultimate disposal (e.g., to an offsite facility). The scrubbed flue gas 106 may pass through the filter socks 202 and exit the baghouse 200 through the baghouse outlet 205 as a filtered flue gas 206. The filtered flue gas 206 exiting the baghouse may be significantly free of SO₂ and PM. The filtered flue gas 206 may then be directed to a mist eliminator 300. In some embodiments, the baghouse may receive the flue gas stream 105 from the flue gas source before the flue gas stream is directed to the caustic scrubber system 99. For example, if the flue gas stream 105 received is hot enough (e.g., above the saturation temperature), the heat of compression from the blower 150 may not be required. If the flue gas is above the saturation temperature when received by the baghouse 200 such that the heat of compression of the blower 150 is not required, the blower 150 may be moved to another location in the system 10, such as in the filtered flue gas stream 14 before the mist eliminator 300 or in the polished flue gas stream 16 after the mist eliminator 300.

When starting up the system, flue gas 106 may be recycled through the baghouse 200 and the blower 150 repeatedly until the flue gas 106 reaches the desired process operating temperature due to the heat of compression of the blower 150. In the absence of the blower's heat of compression, a heat source or heat exchanger would have to be added to the system. The addition of heating equipment lowers the process efficiency, adds pressure drop, adds cost, and expands the footprint of the system.

Performance requirements and specifications for a baghouse according to an example embodiment are shown in Tables 5 and 6 below. In other embodiments, these specifications target concentrations may vary.

TABLE 5
Baghouse Performance Requirements

| | INLET | OUTLET |
|---|---|---|
| Flow (acfm) | 11,984 | 11,984 |
| Temperature (° F.) | 185 | 185 |
| Pressure (psia) | 3.6 | 3.4 |
| Particulate Matter (lb/h) | 4.1 | 0.004 |

TABLE 6
Baghouse Specifications

| PARAMETER | SPECIFICATION |
|---|---|
| MODEL | Custom |
| TYPE | Pulsed Jet Cleaning |
| FABRIC FILTER HEIGHT (FT) | 42 |
| LENGTH (FT) | 12 |
| WIDTH (FT) | 12 |
| SHIPPING WEIGHT (TONS) | 35 |
| FILTER AREA (SQ. FT) | 3.617 |
| ROTARY SCREW MOTOR | 3 HP, 460 V, 3 Phase, 60 Hz |
| FILTERS | 192-6″ diam × 12 ft |
| PULSED JET CLEANING | 25 SCFM @ 90 PSIG |

### Mist Eliminator

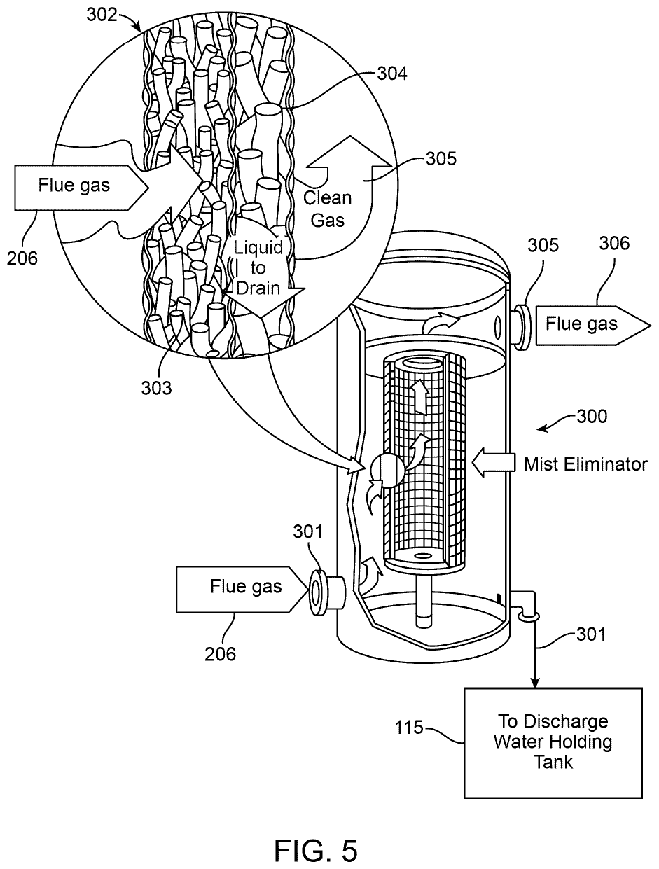

FIG. 5 illustrates a mist eliminator 300 for reducing SO₃ aerosols and remaining PM. The filtered flue gas 206 exiting the baghouse outlet 205 may be directed to a mist eliminator inlet 301 of the mist eliminator 300. The filtered flue gas 206 may travel up through the mist eliminator 300, which may include filter elements 302 (e.g., spiral wound fine filter elements, demister pads, etc.). The filter elements 302 contain fine collecting fibers 303 that may accumulate SO₃ and remaining PM as the flue gas flows through them. Liquid collected in the pads may drain to the bottom of the mist eliminator through draining and re-entrainment control fibers 304.

The filter elements 302 may be periodically sprayed with an air and water spray to remove any collected SO₃ and PM. For example, the surface of the filter elements 302 may be sprayed periodically (e.g., once per day) for a brief period (e.g., approximately 20 minutes) at a specific wash rate, (e.g., 20 gallons per hour). The SO₃ may mix and react with the water in the spray to form liquid sulfuric acid. The liquid may collect at the bottom of the mist eliminator 300 until it can be pumped out. In some embodiments, the collected SO₃ and PM by other methods than spraying water, such as by spraying pulsed air. The filtered flue gas 206 may then exit the mist eliminator 300 via the mist eliminator outlet 305 as polished flue gas 306, where it may be directed to a fuel cell stack or may be used for other purposes. In some embodiments, CO₂ can be captured from the polished flue gas 306 for storage or for other industrial uses. A molten carbonate fuel cell, for example, may be used to separate CO₂ from the oxygen, nitrogen, and other constituents of the polished flue gas 306. The polished flue gas 306 may be supplied to a cathode of the molten carbonate fuel cell. The cathode may convert the carbon dioxide in the polished flue gas 306 to carbonate ions, which cross over an electrolyte to an anode where the carbonate ions are converted back to carbon dioxide. The carbon dioxide on the anode side can be captured, while the other gases in the polished flue gas 306 may pass through the cathode without crossing the electrolyte.

According to an exemplary embodiment, the mist eliminator 300 may remove 99.9% of the SO₃ from the filtered flue gas 206, reducing the concentration to around 0.002 ppm in the polished flue gas 306. The removal of SO₂ and PM by the caustic scrubber 100 and baghouse 200 improves the efficiency of SO₃ removal by the mist eliminator 300, because there are fewer additional contaminants that may accumulate on the filter elements 302.

The mist eliminator 300 may also remove most of the remaining PM from the filtered flue gas 206. The polished flue gas 306 may, for example, have a PM concentration of around 5-25 micrograms per cubic meter, more than 99.9% lower than the flue gas stream 105 output from the power plant.

The liquid pumped out of the mist eliminator 300 may then be directed to the discharge water holding tank 115 via the drain 307. The pumped-out acidic liquid may be combined in the discharge water holding tank 115 with higher pH liquid waste from elsewhere in the polishing system 10. The contents of the discharge water holding tank 115 may be neutralized with high pH liquid such as a solution of NaOH. The contents of the discharge water holding tank 115 may then be disposed of.

Performance requirements and specifications for a mist eliminator according to an example embodiment are shown in Tables 7 and 8 below. In other embodiments, these specifications and target concentrations may vary.

TABLE 7
Mist Eliminator Performance Requirements

| | INLET | OUTLET |
|---|---|---|
| Flow (acfm) | 11,984 | 11,984 |
| Temperature (° F.) | 185 | 185 |
| Pressure (psia) | 3.4 | 2.9 |
| SO₃ / H₂SO₄ (ppm) | 2 | 0.002 |

TABLE 8
Mist Eliminator Specifications

| PARAMETER | SPECIFICATION |
|---|---|
| MODEL | Fiber Bed |
| TYPE | FRP Vessel with Derakane 470 |
| | Wound Filaments |
| MIST ELIMINATOR HEIGHT (FT) | 16.5 |
| DIAMETER (FT) | 10.5 |
| NUMBER OF ELEMENTS | 10 |
| WEIGHT (LB) | 21,700 |
| WASH WATER (GPH) | 33.9 |
| AIR FLOW (CFM) | 20.3 |

### Water Usage

The combined water usage of the polishing system 10, including the caustic scrubber 100, baghouse 200, and mist eliminator 300, may be in the range of approximately 0.5 to 0.6 gallons per minute to process 12,000 scfm of flue gas 105 from a power plant. This water usage rate is considerably lower than conventional flue gas polishing solutions. For example, a flow rate in excess of 30 gpm may be needed for a wet electrostatic precipitator if used in place of the baghouse. A flow rate of approximately 4 to 5 gpm may be used for a venturi scrubber if used in place of the caustic scrubber system 99 for a comparable flue gas flow.

Disclosed herein are various embodiments of systems and methods for polishing power plant flue gas for use in fuel cells. The various embodiments described herein may be capable of reducing the amount of PM, SO₂, and SO₃ contaminants reaching the fuel cells, resulting in higher fuel cell efficiency and life.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the Figures. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention. For example, the heat recovery heat exchangers may be further optimized.

The hardware and data processing components used to implement the various processes, operations, illustrative logics, logical blocks, modules and circuits described in connection with the embodiments disclosed herein (e.g., the controller) may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the controller may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory device (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory device may be communicably connected to the processor to provide computer code or instructions to the processor for executing at least some of the processes described herein. Moreover, the memory device may be or include tangible, non-transient volatile memory or non-volatile memory. Accordingly, the memory device may include database components, object code components, script components, or any other type of information structure for supporting the various activities and information structures described herein.

What is claimed is:

1. A caustic scrubber for removing SO₂ from flue gas for use in a fuel cell assembly, the caustic scrubber comprising:
a caustic scrubber tower including a packed bed of material;
a flue gas inlet configured to direct a flue gas into the caustic scrubber tower;
a scrubber solution pump configured to pump a scrubber solution comprising NaOH and H₂O₂ into the caustic scrubber tower; and
a spent scrubber solution outlet configured to discharge spent scrubber solution comprising sulfur salts formed from a reaction between the scrubber solution and SO₂ in the flue gas.

2. The caustic scrubber of claim 1, further comprising a scrubber solution recycle line configured to direct a portion of the scrubber solution from the caustic scrubber tower to the scrubber solution pump.

3. The caustic scrubber of claim 1, wherein the spent scrubber solution outlet is configured to discharge the scrubber solution from the caustic scrubber tower at a drain rate of about 0.5 gallons per minute to about 1.0 gallon per minute, the caustic scrubber further comprising a controller configured to control the scrubber solution pump to supply the fresh scrubber solution into the caustic scrubber tower at a rate about equal to the drain rate.

4. The caustic scrubber of claim 1, further comprising a controller configured to control an amount of H₂O₂ and an amount of NaOH added to the scrubber solution.

5. The caustic scrubber of claim 4, further comprising a pH sensor configured to monitor the pH of the scrubber solution, wherein the controller is configured to control a feed rate of NaOH added to the scrubber solution based on the measured pH of the scrubber solution to maintain the pH between about 5.0 and about 5.5.

6. The caustic scrubber of claim 5, further comprising a mixing vessel configured to mix a sample of the spent scrubber solution with a reducing agent to form a test sample and an oxidation reduction potential sensor configured to monitor the oxidation reduction potential test sample.

7. The caustic scrubber of claim 6, wherein the controller is configured to control the amount of H₂O₂ added to the scrubber solution to maintain the oxidation reduction potential of the test sample above about 200 mV.

8. The caustic scrubber of claim 3, further comprising a mixing vessel configured to mix a sample of the spent scrubber solution with a reducing agent to form a test sample and an oxidation reduction potential sensor configured to monitor the oxidation reduction potential of the test sample.

9. The caustic scrubber of claim 8, wherein the controller is configured to control the amount of H₂O₂ added to the scrubber solution to maintain the oxidation reduction potential of the test sample above about 200 mV.

10. The caustic scrubber of claim 8, wherein the controller is configured to control the amount of H₂O₂ added to the scrubber solution to maintain the oxidation reduction potential of the spent scrubber solution mixed with a reducing agent above about 300 mV.

11. A method of controlling an amount of H₂O₂ added to a scrubber solution in a caustic scrubber, the method comprising:
applying a scrubber solution comprising a caustic solution and H₂O₂ to a flue gas comprising SO₂;
combining a sample of spent scrubber solution output from an outlet of the caustic scrubber with a reducing agent to form a test sample;
measuring the oxidation reduction potential of the test sample; and
adding additional H₂O₂ to the scrubber solution via an inlet of the caustic scrubber in response to determining that the oxidation reduction potential of the test sample has fallen below a predetermined minimum level.

12. The method of claim 11, wherein the reducing agent comprises one or more materials selected from the group consisting of sodium metabisulfite, sodium sulfite, and sodium bisulfite.

13. The method of claim 11, wherein the predetermined minimum level of oxidation reduction potential is about 200 mV.

14. The method of claim 13, wherein the predetermined minimum level of oxidation reduction potential is about 300 mV.

15. A system for polishing flue gas from a power plant, the system comprising:
a caustic scrubber configured remove SO₂ from the flue gas;
a baghouse configured to remove particulate matter from the flue gas; and
a mist eliminator configured to remove SO₃ from the flue gas.

16. The system of claim 15, further comprising a primary blower configured to heat the flue gas by heat of compression.

17. The system of claim 16, wherein the primary blower is configured to heat the flue gas to a temperature above the dew point of the flue gas before the flue gas is received by the baghouse.

18. The system of claim 15, wherein the caustic scrubber is configured to receive the flue gas from the power plant, the baghouse is configured to receive the flue gas from the caustic scrubber, and the mist eliminator is configured to receive the flue gas from the baghouse.

19. The system of claim 15, wherein the caustic scrubber comprises a scrubber solution comprising NaOH and H₂O₂.

20. The system of claim 19, further comprising a controller configured to add additional H₂O₂ to the scrubber solution via an inlet of the caustic scrubber in response to determining that an oxidation reduction potential of a sample of spent scrubber solution mixed with a reducing agent has fallen below a predetermined minimum level.
